(19) United States
(12) Patent Application Publication
(10) Pub. No.: US 2025/0084679 A1
(43) Pub. Date: Mar. 13, 2025

(54) DOOR CHECK

(71) Applicant: Austin Hardware & Supply, Inc., Lee's Summit, MO (US)

(72) Inventors: Robert Walden, Buford, GA (US); Mark Steven Jeffries, Buford, GA (US)

(21) Appl. No.: 18/885,204

(22) Filed: Sep. 13, 2024

Related U.S. Application Data
(60) Provisional application No. 63/538,202, filed on Sep. 13, 2023.

(51) Int. Cl. E05C 17/26

(52) U.S. Cl. CPC E05C 17/26

(57) ABSTRACT

A door check for a cabinet and door is described. The door check includes a ball pivot. The ball pivot includes a passage. The ball pivot includes a spherical or rounded exterior surface. The door check further includes a first guide having a passage and a socket end. The door check further includes a second guide having a passage and a socket end. The door check further includes a first spring and a second spring. The rod passes through an interior of the first spring, an interior of the second spring, the passage of the first guide, the passage of the ball pivot, and the passage of the second guide. The socket ends move or slide against the spherical or rounded exterior surface of the ball pivot.

The present application claims priority to U.S. Provisional Application No. 63/538,202, filed Sep. 13, 2023, which is incorporated by reference.

### FIELD OF INVENTION

The present invention relates to a door check.

### BACKGROUND OF INVENTION

Door checks are commonly used to provide the controlled opening and closing of doors. Door checks commonly use a spring and rod construction, which often suffers from bothersome squeaks and noises as the spring expands and contracts. These squeaks and noises are often caused by buckling or waves in the spring that rub against a rod of the door check.

### SUMMARY OF INVENTION

A door check is described. The door check in installed on a cabinet and door to assist in controlling the opening and closing of the door. The door check provides quiet operation. The door check reduces the squeaking and rubbing of its springs. The door check is flexible to accommodate a range of tolerances during installation.

In one aspect, the door check includes a ball pivot. The ball pivot includes a passage. The ball pivot includes a spherical or rounded exterior surface. The door check further includes a first guide having a passage and a socket end. The door check further includes a second guide having a passage and a socket end. The rod is configured to pass through the passage of the ball pivot, the passage of the first guide, and the passage of the second guide. The socket ends are configured to move or slide against the spherical or rounded exterior surface of the ball pivot. A combination of the ball pivot, the first guide, and the second guide provide for flexibility and increased range of motion for the door check.

In another aspect, a first spring is positioned on a rod between a middle guide and a first end of the rod, a second spring is positioned on the rod between the middle guide and a ball pivot, and a rear spring is positioned on the rod between the ball pivot and a second end of the rod. The first spring is separate from the second spring, and the middle guide is positioned on the rod between the first spring and the second spring. The use of the first and second springs helps to prevent or reduce buckling and/or rubbing of the springs against the rod.

In another aspect, a door check for a cabinet is described. The door check includes a rod. The door check includes a ball pivot. The ball pivot includes a passage. The ball pivot includes a spherical or rounded exterior surface. The door check includes a first guide that includes a passage and a socket end. The door check includes a second guide that includes a passage and a socket end. The rod is configured to pass through the passage of the ball pivot, the passage of the first guide, and the passage of the second guide. The socket ends are configured to move or slide against the spherical or rounded exterior surface of the ball pivot.

In another aspect, a door check for a cabinet is described. The door check includes a rod. The door check includes a ball pivot. The ball pivot includes a passage. The ball pivot includes a spherical or rounded exterior surface. The door check includes a first spring. The door check includes a second spring. The door check includes a guide, which includes a passage, a socket end, and a spring engagement end. The first spring that includes a first end, a second end, and an interior. The second spring that includes a first end, a second end, and an interior. The rod is configured to pass through the interior of the first spring, the interior of the second spring, and the passage of the ball pivot. The first spring is configured to bias or abut against the second spring. The second spring is configured to bias or abut against the spring engagement end of the guide.

In another aspect, a door check for a cabinet is described. The door check includes a rod. The door check includes a ball pivot. The ball pivot includes a passage. The ball pivot includes a spherical or rounded exterior surface. The door check includes a first guide that includes a passage, a socket end, and a first spring engagement end. The door check includes a second guide that includes a passage, a socket end, and a second spring engagement end. The door check includes a first spring that includes an interior. The door check includes a second spring that includes an interior. The door check includes a middle guide that includes a passage. The door check includes a rear spring that includes an interior. The rod is configured to pass through the interior of the first spring, the passage of the middle guide, the interior of the second spring, the passage of the first guide, the passage of the ball pivot, the passage of the second guide, and the interior of the rear spring. The middle guide is positioned between the first spring and the second spring. The first spring is configured to bias or abut against the second spring. The second spring is configured to bias or abut against the first spring engagement end. The rear spring configured to bias or abut against the second spring engagement end.

In another aspect, a door check for a cabinet is described. The door check includes a rod. The door check includes a rod support that includes a passage. The door check includes a guide that includes a passage, a first end proximate the rod support, and a second end proximate the second spring. The door check includes a first spring that includes a first end, a second end, and an interior. The door check includes a second spring that includes a first end, a second end, and an interior. The rod is configured to pass through the interior of the first spring, the interior of the second spring, the passage of the guide, and the passage of the rod support. The first spring is configured to bias or abut against the second spring, and the second spring is configured to bias or abut against the second end of the guide.

In another aspect, a door check for a cabinet is described. The door check includes a rod. The door check includes a rod support that includes a passage. The door check includes a first spring and a second spring. The first spring includes a first end, a second end, and an interior. The second spring includes a first end, a second end, and an interior. A rear spring includes a first end, a second end, and an interior. The rod is configured to pass through the interior of the first spring, the interior of the second spring, the passage of the rod support, and the interior of the rear spring. The first spring is configured to bias or abut against the second spring. The second spring is configured to bias or abut against a first side of the rod support. The rear spring is configured to bias or abut against a second side of the rod support. The rear spring includes a conical spring. The conical spring provides progressively increasing bias as the conical spring is compressed.

In another aspect, a door check for a cabinet is described. The door check includes a rod. The door check includes a rod support that includes a passage. The door check includes a main spring. The main spring includes a first end, a second end, and an interior. A rear spring includes a first end, a second end, and an interior. The rod is configured to pass through the interior of the main spring, the passage of the rod support, and the interior of the rear spring. The main spring is configured to bias or abut against a first side of the rod support. The rear spring is configured to bias or abut against a second side of the rod support. The rear spring includes a conical spring.

In another aspect, a door check for a cabinet is described. The door check includes a support structure mounted to the cabinet or the cabinet frame. The support structure includes a socket. The door check further includes a ball guide. The ball guide is configured to receive a rod. The ball guide includes a ball portion. The socket of the support structure is configured to receive the ball portion of the ball guide in a movable engagement.

In another aspect, a door check for a cabinet is described. The door check includes a rod. The door check includes a ball guide having a ball portion and a passage. The ball portion includes a spherical or rounded exterior surface. The passage passes through the ball portion. The passage is configured to receive the rod. The door check includes a support structure. The support structure includes an interior and a socket surface. The interior of the support structure is configured to receive the ball portion of the ball guide in a movable engagement against the socket surface.

In another aspect, a support structure is mounted to the cabinet or frame. The support structure provides a socket surface that is configured to receive a rounded surface of a guide structure. The guide structure is configured to receive a rod. The guide structure is held by the support structure in a movable engagement, and the guide structure is configured to move relative to the support structure.

### BRIEF DESCRIPTION OF DRAWINGS

FIG. 1 is a perspective view of the door check.

FIG. 2 is a view of the door check installed on the cabinet and door.

FIG. 3 is a view of the door check, cabinet, and door in a closed position.

FIG. 4 is a view of the door check, cabinet, and door in a partially open position.

FIG. 5 is a view of the door check, cabinet, and door in an open position.

FIG. 6 is a view of the door check showing the lateral movement of the rod relative to the ball pivot.

FIG. 7 is a view of the door check showing the vertical movement of the rod relative to the ball pivot.

FIG. 8 is a sectional view of the door check.

FIG. 9 is a sectional view of the door check proximate the ball pivot.

FIG. 10 is an exploded view of the door check.

FIG. 11 is a perspective view of the ball pivot.

FIG. 12 is a perspective view of a second door check.

FIG. 13 is an exploded view of the second door check.

FIG. 14 is a sectional view of the second door check.

FIG. 15 is a perspective view of the ball guide and support structure of the second door check.

FIG. 16 is an exploded view of the ball guide and support structure of the second door check.

FIG. 17 is a sectional view of the ball guide and support structure of the second door check.

### DETAILED DESCRIPTION

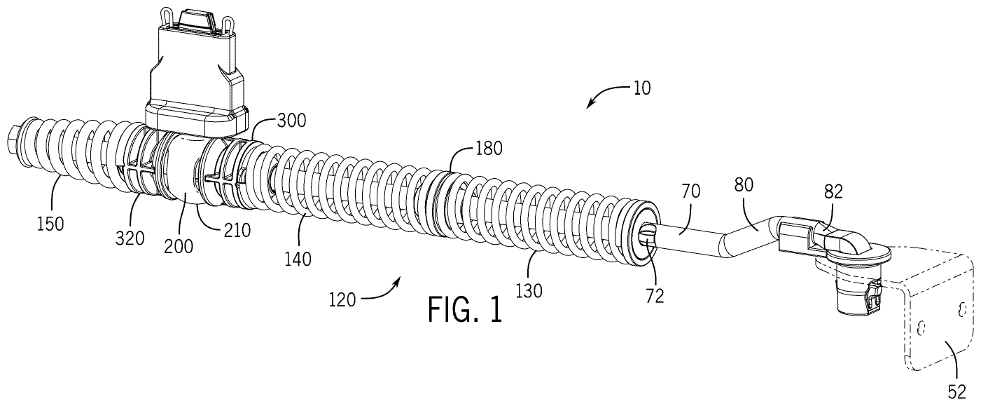

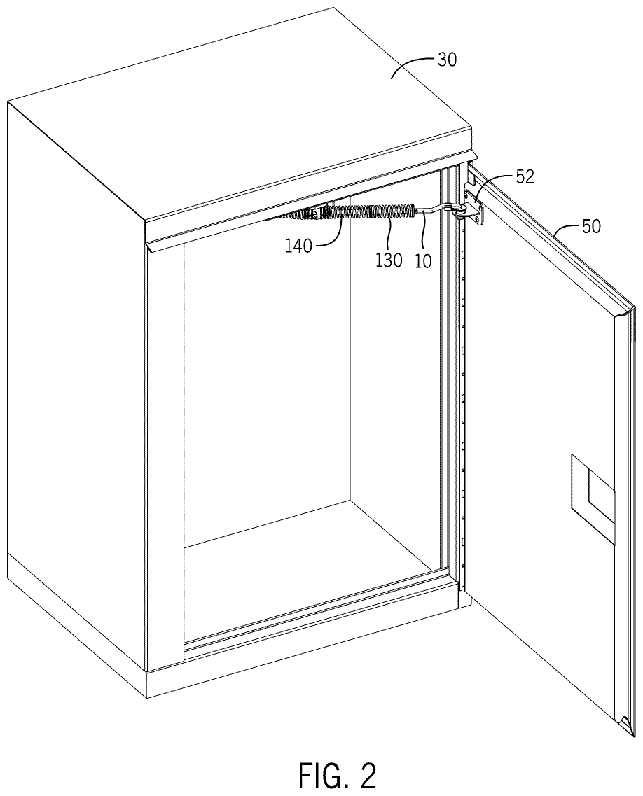

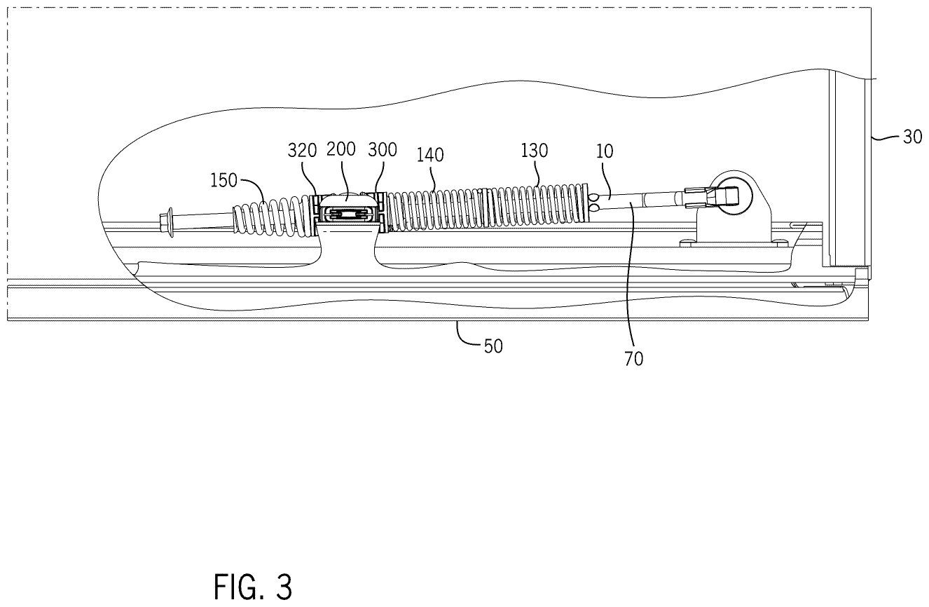

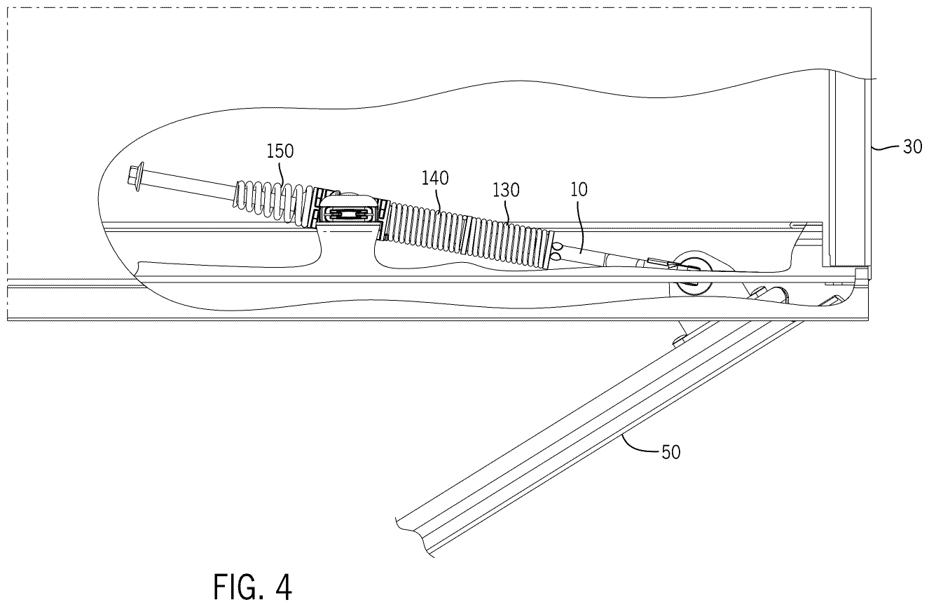

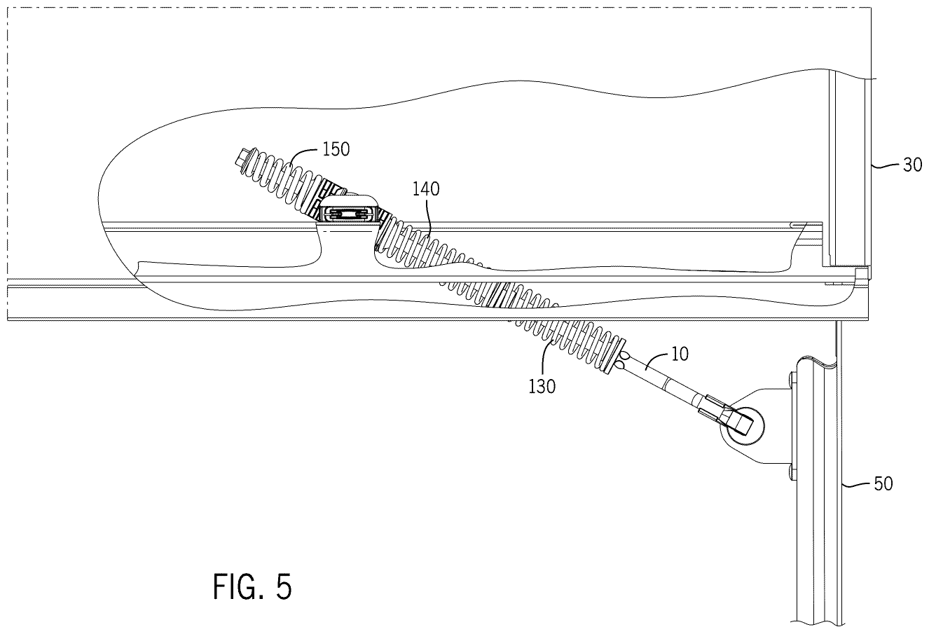

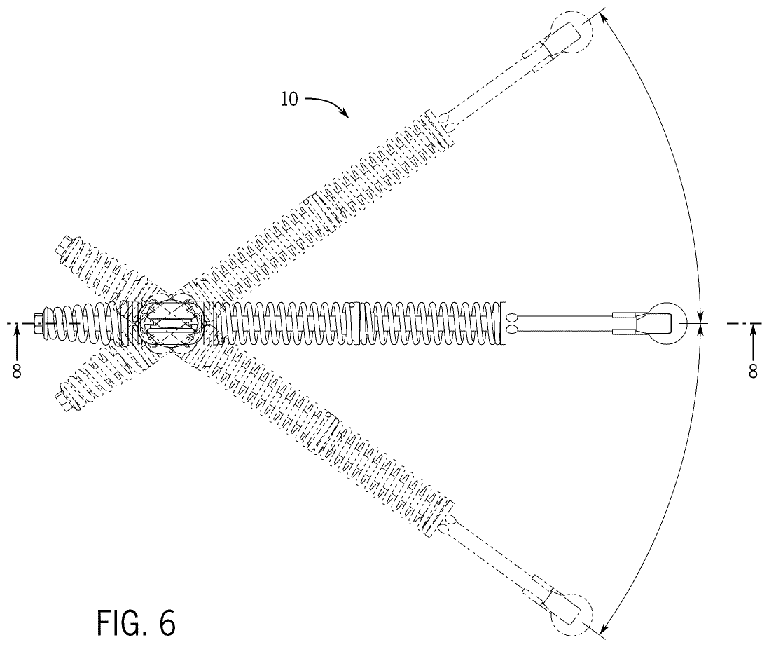

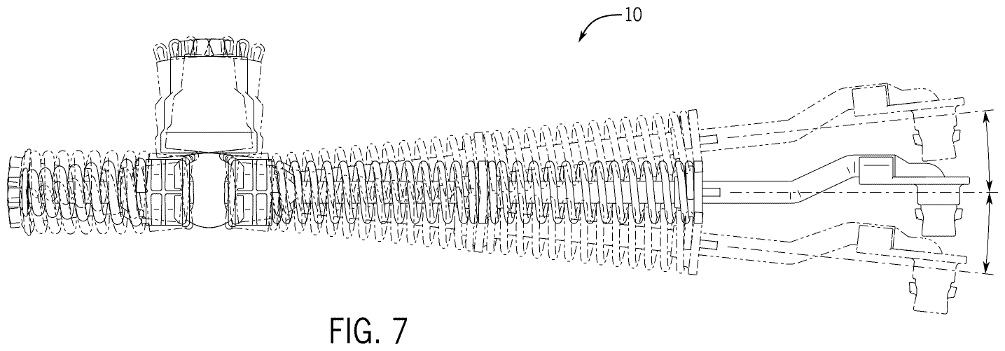

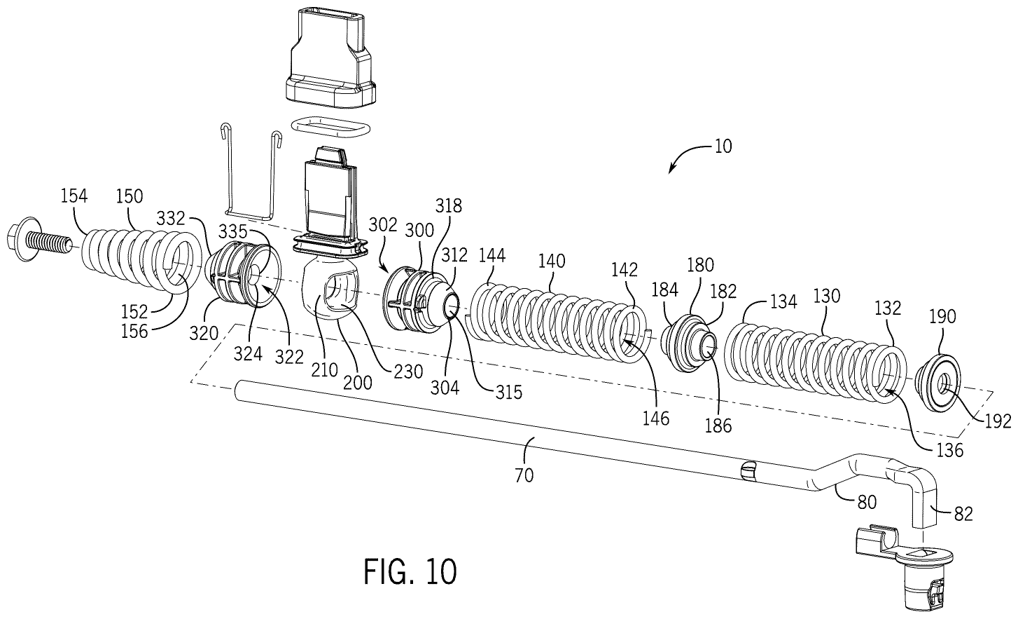

A door check 10 will now be described with references to FIGS. 1-11. The door check 10 connects to a cabinet 30 and a door 50. The door 50 is typically hingedly engaged to the cabinet 30. The door check 10 assists in controlling the opening and closing of the door 50. The cabinet 30 may be installed on a truck body or a utility vehicle. The door check 10 may also be used in storage cabinets and doors of non-moving assemblies.

The door check 10 includes a rod 70. A main spring 120 biases the door 50 to both an open position and a closed position. The rod 70 is inserted through an interior of the main spring 120. In this aspect, the main spring 120 includes a first spring 130 and a second spring 140. In other aspects, the door check 10 may include three or more springs.

The rod 70 includes a first end 80 and a second end 90. The first end 80 secures to the door 50. The first end 80 may include an end portion 82 that connects or engages with a bracket 52 positioned on an interior surface of the door 50. During installation, the end portion 82 may be engaged to the bracket 52 to connect the door check 10 to the door 50. The end portion 82 may include a hook shape or an angled portion that engages to an opening in the bracket 52.

The first spring 130 and the second spring 140 cushion or slow the closing movement of the door 50. The first spring 130 and the second spring 140 help to reduce the door 50 from slamming to the closed position. Further, the first spring 130 and the second spring 140 may provide a bias to assist in the opening movement of the door 50.

In this aspect, the door check 10 further includes a rear spring 150. The rear spring 150 absorbs energy from the door 50 as the door 50 moves to the fully open position. This saves wear and tear on the door 50 and the door check 10. In this aspect, the rear spring 150 is a conical or helical spring, which provides increased resistance to compression. The conical or helical spring may provide a non-linear bias that progressively increases in bias as the conical or helical spring is compressed. This helps to prevent or reduce the bottoming-out of the door 50 and/or to prevent or reduce the door 50 from moving or flying to the open position in an uncontrolled manner. The first spring 130 and the second spring 140 may include a linear biasing spring, while the rear spring 150 may include a conical spring. In this aspect, the rear spring 150 is a different type or style than the first spring 130 and the second spring 140.

In this aspect, the first spring 130 and the second spring 140 are separated by a middle guide 180. The first spring 130 includes a first end 132 and a second end 134. The first spring 130 includes an interior 136. The second spring 140 includes a first end 142 and a second end 144. The second spring 140 includes an interior 146. The rear spring 150 includes a first end 152 and a second end 154. The rear spring 150 includes an interior 156.

The first spring 130 is positioned on the rod 70 between the middle guide 180 and the first end 80 of the rod 70. The second spring 140 is positioned on the rod 70 between the middle guide 180 and the ball pivot 200. The rear spring 150 is positioned on the rod 70 between the ball pivot 200 and the second end 90 of the rod 70.

The door check 10 further includes the ball pivot 200. An upper portion of the ball pivot 200 includes a connection member 220 that connects to a frame 32 of the cabinet 30. The ball pivot 200 supports the rod 70. The ball pivot 200 includes a spherical or rounded exterior surface 210. A passage 230 passes through the ball pivot 200. When the door check 10 is installed, the rod 70 passes through the passage 230. The passage 230 includes a first opening 233 and a second opening 236.

The connection member 220 may include a stud, bracket, or other mechanical attachment suitable to affix the ball pivot 200 to the cabinet 30 or the frame 32 of the cabinet 30. In other aspects, the connection member 220 may be directly welded to the cabinet 30 or its frame 32. The connection member 220 may include an opening that receives a bolt or other connection member to attach the connection member 220 to the cabinet 30.

The rod 70 further includes a first guide 300 and a second guide 320. The first guide 300 includes a socket end 302 and a first spring engagement end 312. The socket end 302 includes a first opening 304, while the first spring engagement end 312 includes a second opening 314. A passage 315 passes through the first guide 300 and connects the first opening 304 and the second opening 314. Similarly, the second guide 320 includes a socket end 322 and a second spring engagement end 332. The socket end 322 includes a first opening 324, while the second spring engagement end 332 includes a second opening 334. A passage 335 passes through the second guide 320 and connects the first opening 324 and the second opening 334. The passages 315 and 335 centers the first guide 300 and the second guide 320, respectively, on the rod 70. A passage 186 of the middle guide 180 further centers the middle guide 180 on the rod 170. This helps to reduce contact from springs 130, 140, and 150 against the rod 70.

A stop guide 190 is further positioned on the rod 70. The first end 132 of the first spring 130 abuts or biases against the stop guide 190. The rod 70 passes through a passage 192 of the stop guide 190. The stop guide 190 is generally not permitted to move laterally toward the first end 80 of the rod 70 by a widened portion 72 formed in the rod 70. The passage 192 may catch against the widened portion 72 and be prevented from moving along the rod 70 toward the first end 80 of the rod 70.

When assembled, the rod 70 passes through the interior 136 of the first spring 130, the interior 146 of the second spring 140, and the interior 156 of the rear spring 150. The first end 132 of the first spring 130 abuts or biases against the stop guide 190. The second end 134 of the first spring 130 abuts or biases against a first side 182 of the middle guide 180. The first end 142 of the second spring 140 abuts or biases against a second side 184 of the middle guide 180. The second end 144 of the second spring 140 abuts or biases against the first spring engagement end 312 of the first guide 300. The first end 152 of the rear spring 150 abuts or biases against the second spring engagement end 332 of the second guide 320. In this aspect, the first spring 130 and the second spring 140 are two separate spring structures. In this aspect, the first spring 130 and the second spring 140 are two separate spring structures that are positioned on opposite sides of the middle guide 180. With reference to FIG. 9, in this aspect, the first spring engagement end 312 and the second spring engagement end 332 include conical surfaces that assist in centering the respective springs ends 144 and 152 to the first spring engagement end 312 and the second spring engagement end 332. The conical surfaces wedge into the spring ends 144 and 152 and assist in centering the springs 140 and 150 on the rod 70. The first spring engagement end 312 may include a flange or catch portion 318 that is generally perpendicular to the bias of the of second end 144 of the second spring 140. Similarly, the second spring engagement end 332 may include a flange or catch portion 338 that is generally perpendicular to the bias of the of the first end 152 of the rear spring 150. The spring ends 144 and 152 may abut or press against the flange or catch portions 318 and 338.

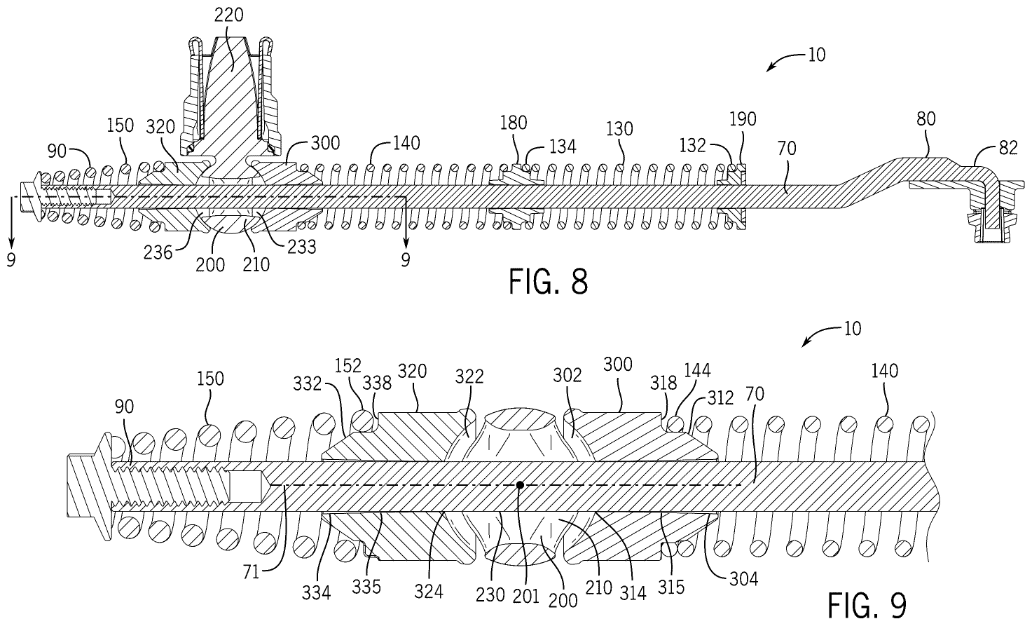

With respect to FIGS. 8 and 9, the rod 70 passes through the passage 315 of the first guide 300, the passage 230 of the ball pivot 200 and the passage 335 of the second guide 320. The socket ends 302 and 322 include a concave or cup-like shape that partially receives the spherical exterior surface 210 of the ball pivot 200. The spherical exterior surface 210 of the ball pivot 200 fits or partially fits into the cup-like structure of the socket ends 302 and 322. The socket ends 302 and 322 articulate against the spherical exterior surface 210 of the ball pivot 200 as the door 50 moves to and from the open and closed positions. The spherical or rounded exterior surface 210 may include a convex surface that receives a concave exterior of the socket ends 302 and 322. The spherical or rounded exterior surface 210 may wholly or partially fit into or within the socket ends 302 and 322. In certain aspects, the socket end 302 of the first guide 300 and the socket end 322 of the second guide 320 are configured to move or slide against opposite sides of the spherical or rounded exterior surface 210 of the ball pivot 200. In certain aspects, the spherical exterior surface 210 of the ball pivot 200 may include two spherical or rounded surfaces separated by a flatter or less curved central portion.

The ball pivot 200 is generally fixed in position at the frame 32 or perimeter of the cabinet 30. The ball pivot 200 does not rotate or spin relative to the cabinet 30. Instead, the socket ends 302 and 322 and the rod 70 move relative to the ball pivot 200. Further, the rod 70 may slide through and back through the passage 230 of the ball pivot 200 as the door 50 moves between the open and closed positions.

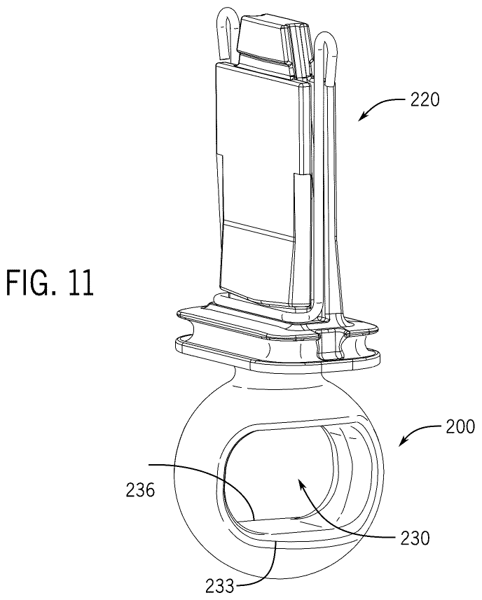

A combination of the ball pivot 200, the first guide 300, and the second guide 320 provide for flexibility and increased range of motion for the door check 10. This makes installation of the door check 10 easier, as installation tolerances are broadened or cased. Further, the flexibility and increased range of motion for the door check 10 is helpful in instances when the cabinet 30 or door the door 50 is not square or is misaligned. With respect to FIG. 11, the passage 230 of the ball pivot 200 may include an elongate shape, such as a stadium or oval rectangle, to provide for range of motion. For example, the rod 70 may pivot or tilt approximately 2 degrees to approximately 12 degrees in a vertical direction relative to the ball pivot 200, and the rod 70 may pivot or tilt approximately 20 degrees to approximately 50 degrees in a horizontal direction relative to the ball pivot 200. As the rod 70 moves vertically and/or horizontally, the socket ends 302 and 322 slide or move against the spherical exterior surface 210 of the ball pivot 200.

As the door 50 moves to and from the open and closed positions, the socket ends 302 and 322 of the first guide 300 and the second guide 320 articulate against the spherical exterior surface 210 of the ball pivot 200 and the rod 70 slides through the passage 230 of the ball pivot 200. The combination of the ball pivot 200, the first guide 300, and the second guide 320 provides a spherical capture arrangement. During articulation and strokes of the door check 10, a central axis 71 of the rod 70 remains coincident to a centroid 201 of the ball pivot 200. This allows the second spring 140 and the rear spring 150 to generally stay coaxial to the center axis of the rod 70. The spherical capture arrangement allows the socket ends 302 and 322, the second spring 140 and the rear spring 150, and the rod 70 to rotate through the centroid 201 of the ball pivot 200. There are no side forces between the ball pivot 200, which is fixed, and the moving door check 10. This reduces or prevents the second spring 140 and the rear spring 150 from bending and then rubbing against the rod 70.

As shown in FIG. 9, the central axis 71 of the rod 70 and central axis of the passages 315 and 335 of the first guide 300 and the second guide 320 are coincident. Also, the concave exterior of the socket ends 302 and 322 shares or forms a centroid that is the same as the centroid 201 of the ball pivot 200. This arrangement permits the rod 70 to move in multiple planes and still remain coincident to the centroid 201 of the ball pivot 200.

The socket ends 302 and 322 of the first guide 300 and the second guide 320 hold or maintain the rod 70 passing through the centroid 201 of the ball pivot 200. The passages 315 and 335 of the first guide 300 and the second guide 320 are coincident to the central axis 71 of the rod 70. The socket ends 302 and 322 of the first guide 300 and the second guide 320 are also coincident to the spherical exterior surface 210. As the rod 70 moves relative to the ball pivot 200, the interaction of the socket ends 302 and 322 of the first guide 300 and the second guide 320 about the spherical exterior surface 210 maintains the rod 70 in alignment or passing through the centroid 201 of the ball pivot 200. This prevents the rod 70 from rubbing against an interior of the passage 230 of the ball pivot 200.

The door check 10 utilizes the first spring 130 and the second spring 140, which reduces squeaking or rubbing of the first spring 130 and the second spring 140 against the rod 70. By using two shorter springs, the first spring 130 and the second spring 140 are less likely to bow, buckle, and/or bend and contact or rub against the rod 70. The individual coils of the first spring 130 and the second spring 140 generally do not touch against an exterior surface of the rod 70. This reduces the likelihood of the door check 10 to squeak or make noises as the door 50 moves between the open and closed positions. This provides for quieter operation of the door check 10.

In other aspects, door checks may employ the first spring 130 and the second spring 140, which reduces squeaking or rubbing of the first spring 130 and the second spring 140 against the rod 70. In other aspects, a standard door check with a conventional rod support may employ the first spring 130 and the second spring 140. For example, the rod 70 is configured to pass through the interior of the first spring 130, the interior of the second spring 140, a passage of the rod support, and the interior of the rear spring 150. The first spring 130 is configured to bias or abut against the second spring 140. The second spring 140 is configured to bias or abut against a first side of the rod support. The rear spring 150 is configured to bias against a second side of the rod support. The rod support may include flat, rounded, or curved contact surfaces or sides for the second spring 140 and the rear spring 150 to bias against.

In other aspects, door checks may employ the rear spring 150 in the form of the conical or helical spring. The conical or helical spring may provide a non-linear bias that progressively increases in bias as the conical or helical spring is compressed. This helps to prevent or reduce the bottoming-out of a door and/or to prevent or reduce the door from moving or flying to the open position in an uncontrolled manner. In this aspect, the rear spring 150 may be different type or style than the first spring 130 and the second spring 140. In other aspects, a standard door check may employ the rear spring 150 in the form of the conical or helical spring. In other aspects, a standard door check may employ the rear spring 150 in the form of the conical or helical spring along with a single, main spring.

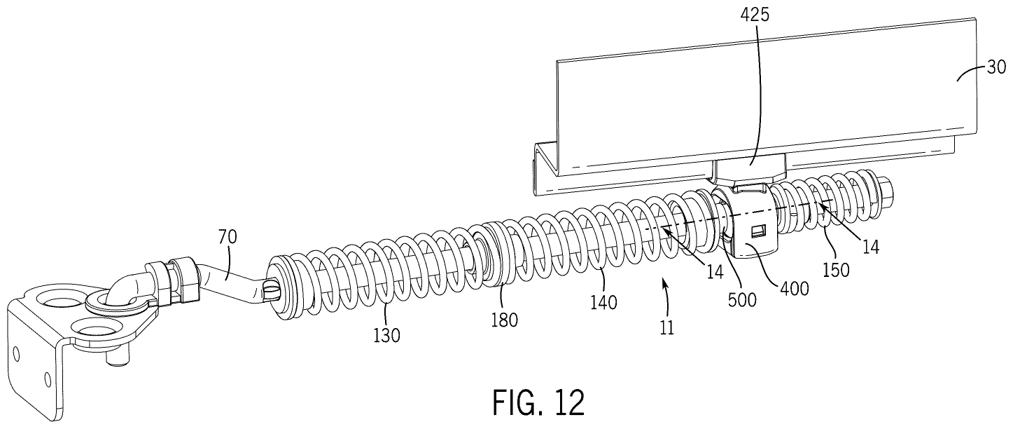

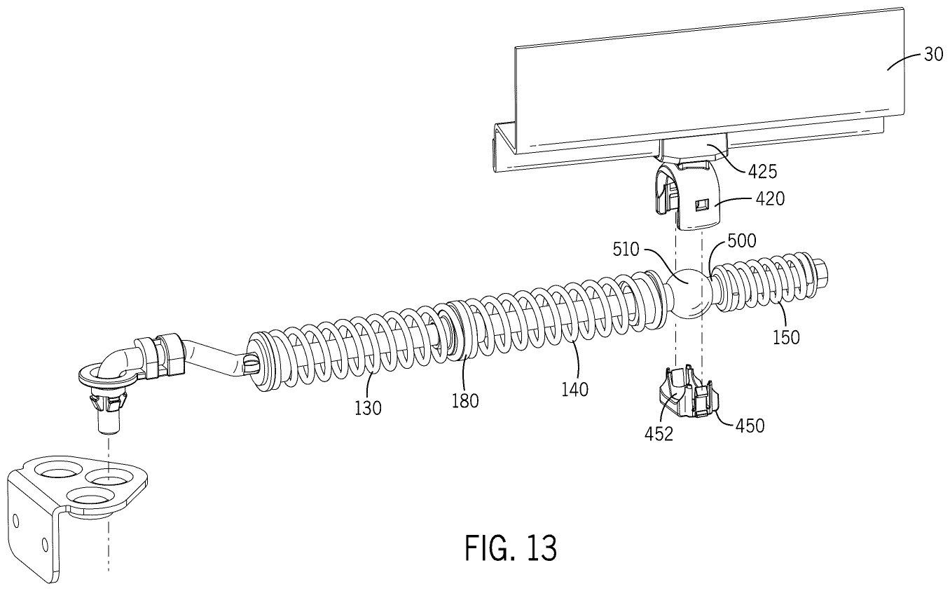

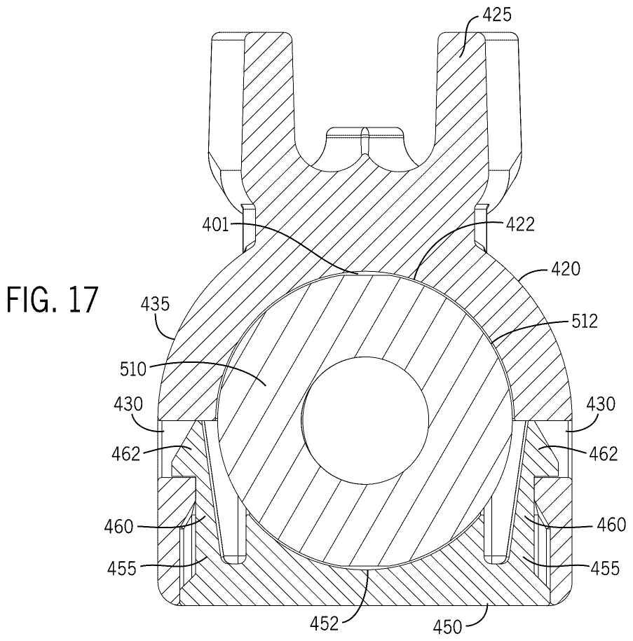

In another aspect, with respect to FIGS. 12-17, a door check 11 is illustrated. The door check 11 reverses the configuration of the ball and socket arrangement of the door check 10. The door check 11 functions in a similar manner as the door check 10, and some similar components may be utilized as described below.

The door check 11 includes a support structure 400 and a ball guide 500. As shown in FIGS. 12-17, the support structure 400 attaches or connects to the cabinet 30 or its frame 32. The support structure 400 holds a ball portion 510 of the ball guide 500 in a movable engagement.

The support structure 400 includes an interior 401 to receive the ball portion 510 of the ball guide 500. A first lateral opening 402 and a second lateral opening 405 of the support structure 400 lead to the interior 401. The support structure 400 forms or defines a socket surface 410 in the interior 401 that receives the ball portion 510 of the ball guide 500 in a movable engagement.

The ball guide 500 includes an internal passage 507 passing through the ball guide 500. The internal passage 507 passes through the ball portion 510 of the ball guide 500. The internal passage 507 receives the rod 70. The ball guide 500 includes a first lateral opening 502 and a second lateral opening 505, which open or connect to the internal passage 507. The internal passage 507 is linear through the ball guide 500. During installation of the door check 11, the rod 70 is passed through the internal passage 507 via the first lateral opening 502 and the second lateral opening 505.

The support structure 400 receives the ball portion 510 of the ball guide 500 in a movable engagement. The ball portion 510 swivels, moves, rotates, etc. with respect to the socket surface 410. The support structure 400 remains generally stationary or fixed in position relative to the cabinet 30 or its frame 32. The support structure 400 provides support to the door check 11, while permitting the ball portion 510 and the rod 70 to move relative to the support structure 400.

In this aspect, the support structure 400 includes an upper portion 420 and a lower portion 450. The upper portion 420 may include a connection member 425 such as a stud, bracket, weldment, or other mechanical attachment suitable to affix the support structure 400 to the cabinet 30 or the frame 32 of the cabinet 30. In this aspect, the connection member 425 extends upward from the upper portion 420. In other aspects, the support structure 400 may include additional bearing surfaces, socket surfaces, or supports to hold or receive the ball portion 510 in a movable engagement. In other aspects, the support structure 400 may receive a bearing or socket structure that fits around or holds the ball portion 510 in a movable engagement. In other aspects, the support structure 400 may include an additional middle portion.

In this aspect, the support structure 400 includes the upper portion 420 and the lower portion 450 to hold or receive the ball portion 510 of the ball guide 500 in a movable engagement. The upper portion 420 and the lower portion 450 join together and form the first lateral opening 402 and the second lateral opening 405.

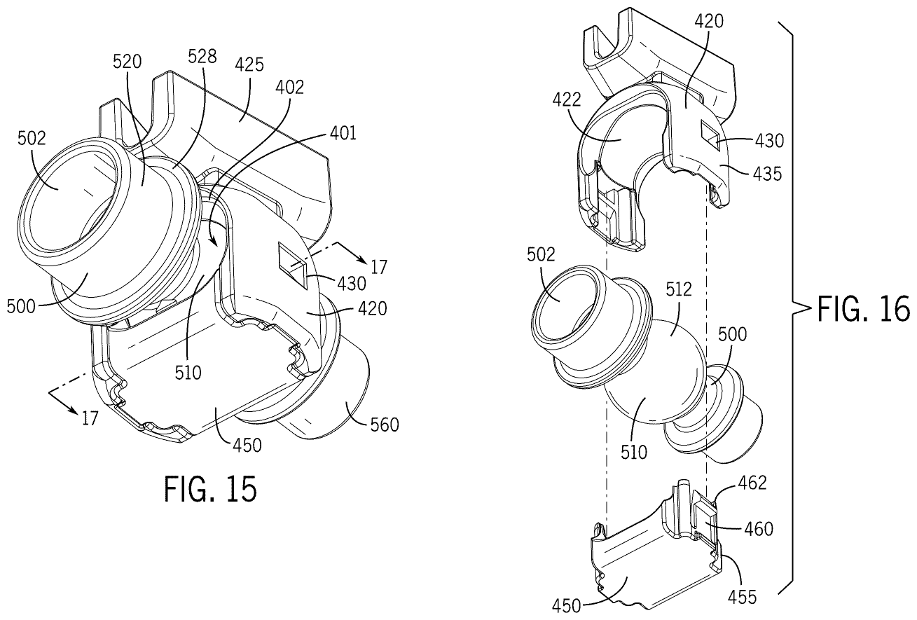

The upper portion 420 forms an upper socket surface 422. The lower portion 450 forms a lower socket surface 452. In this aspect, the upper portion 420 and the lower portion 450 clip or snap together to hold the ball portion 510. As shown in FIGS. 15-17, sidewalls 455 of the lower portion 450 include arms 460 with barbs 462 that fit into openings 430 of sidewalls 435 of the upper portion 420. The arms 460 are resiliently flexible to bias the barbs 462 into the openings 430. In other aspects, the upper portion 420 and the lower portion 450 may be joined with fasteners, hinges, or other connection members.

The upper socket surface 422 and the lower socket surface 452 include a concave or cup-like shape that partially receives a spherical exterior surface 512 of the ball portion 510. The spherical exterior surface 512 of the ball portion 510 fits or partially fits into the cup-like structure of the socket surfaces 422 and 452. The ball portion 510 articulates against the socket surfaces 422 and 452 of the support structure 400 as the door 50 moves to and from the open and closed positions.

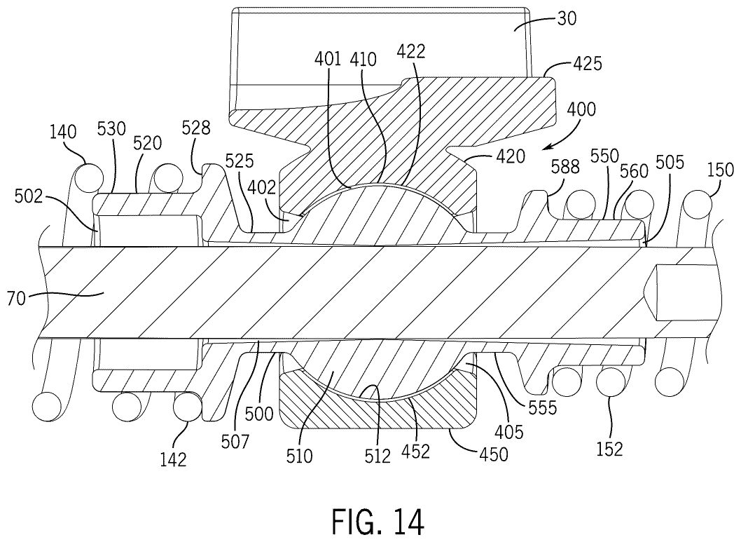

In this aspect, as shown in FIG. 14, the ball guide 500 includes a first narrow portion 525 between the ball portion 510 and the first spring engagement end 520, and the ball guide 500 includes a second narrow portion 555 between the ball portion 510 and the second spring engagement end 550. When the upper portion 420 and the lower portion 450 are joined, the ball portion 510 is held inside of the support structure 400 with the first narrow portion 525 and the second narrow portion 555 extending out of the support structure 400. The first narrow portion 525 extends through the first lateral opening 402 of the support structure 400, and the second narrow portion 555 extends through the second lateral opening 405 of the support structure 400. The ball portion 510 is too large to pass through either of the first lateral opening 402 or the second lateral opening 405. The ball portion 510 is trapped in the interior 401 of the support structure 400.

As shown in FIG. 14, The first spring engagement end 520 includes a flange or catch portion 528 that is generally perpendicular to the bias of the of second end 144 of the second spring 140. Similarly, the second spring engagement end 550 may include a flange or catch portion 588 that is generally perpendicular to the bias of the of the first end 152 of the rear spring 150. The spring ends 144 and 152 may abut or press against the flange or catch portions 528 and 588.

The first spring engagement end 520 includes a first lateral portion 530 with an outer diameter just less than an internal diameter of the second end 144 of the second spring 140. The first lateral portion 530 leads to the first lateral opening 502. The first lateral portion 530 assists in supporting the second spring 140. Similarly, the second spring engagement end 550 includes a second lateral portion 560 with an outer diameter just less than an internal diameter of the first end 152 of the rear spring 150. The second lateral portion 560 leads to the second lateral opening 505. The second lateral portion 560 assists in supporting the rear spring 150.

In this aspect, the socket surface 410 is formed by the upper socket surface 422 and the lower socket surface 452. The socket surface 410 allows the ball guide 500 to move vertically and/or horizontally with respect to the support structure 400. The socket surface 410 of the support structure 400 generally constrains or holds the ball portion 510 of the ball guide 500 such that the ball guide 500 is not removable or separable from the socket surface 410, while allowing the ball portion 510 to articulate with respect to the support structure 400.

As such, it should be understood that the disclosure is not limited to the particular aspects described herein, but that various changes and modifications may be made without departing from the spirit and scope of this novel concept as defined by the following claims. Further, many other advantages of applicant's disclosure will be apparent to those skilled in the art from the above descriptions and the claims below.

What is claimed is:

1. A door check for a cabinet, comprising:
a rod;
a ball pivot, the ball pivot comprising a passage, the ball pivot comprising a spherical or rounded exterior surface;
a first guide comprising a passage and a socket end;
a second guide comprising a passage and a socket end;
the rod is configured to pass through the passage of the ball pivot, the passage of the first guide, and the passage of the second guide; and
the socket ends are configured to move or slide against the spherical or rounded exterior surface of the ball pivot.

2. The door check for a cabinet according to claim 1, further comprising a first spring comprising an interior, a second spring comprising an interior, and a rear spring comprising an interior, the rod is configured to pass through the interior of the first spring, the interior of the second spring, and the interior of the rear spring.

3. The door check for a cabinet according to claim 2, wherein the first guide further comprises a first spring engagement end, wherein the second guide further comprises a second spring engagement end, wherein the second spring is configured to bias or abut against the first spring engagement end, and the rear spring is configured to bias or abut against the second spring engagement end.

4. The door check for a cabinet according to claim 2, wherein the rear spring is a different style of spring than the first and second springs.

5. The door check for a cabinet according to claim 2, wherein the rear spring is a conical spring.

6. The door check for a cabinet according to claim 5, wherein the rear spring provides an increasing resistance force as the rear spring is compressed.

7. The door check for a cabinet according to claim 2, wherein the first spring is positioned on the rod between a middle guide and a first end of the rod, the second spring is positioned on the rod between the middle guide and the ball pivot, and the rear spring is positioned on the rod between the ball pivot and a second end of the rod.

8. The door check for a cabinet according to claim 2, wherein the first spring is separate from the second spring, and a middle guide is positioned on the rod between the first spring and the second spring.

9. The door check for a cabinet according to claim 1, wherein the socket end of the first guide and the socket end of the second guide are configured to move or slide against opposite sides of the spherical or rounded exterior surface of the ball pivot.

10. The door check for a cabinet according to claim 1, wherein the socket ends include a concave or cup-like shape that partially receives the spherical or rounded exterior surface of the ball pivot.

11. The door check for a cabinet according to claim 1, wherein the ball pivot includes a first rounded exterior surface and a second rounded exterior surface, and wherein the first rounded exterior surface and the second rounded exterior surface are on opposite sides of the ball pivot.

12. The door check for a cabinet according to claim 1, wherein further comprising a first spring comprising an interior and a second spring comprising an interior, the rod is configured to pass through the interior of the first spring and the interior of the second spring, and the first spring is configured to bias against the second spring.

13. The door check for a cabinet according to claim 1, wherein an upper portion of the ball pivot includes a connection member, the connection member is configured to connect to a frame of the cabinet, and the ball pivot is configured to support the rod.

14. The door check for a cabinet according to claim 1, wherein the passage of the ball pivot includes a stadium, oval rectangle, or elongate shape.

15. The door check for a cabinet according to claim 1, wherein the rod is configured to pivot or tilt approximately 2 degrees to approximately 12 degrees in a vertical direction relative to the ball pivot and the rod is configured to pivot or tilt approximately 20 degrees to approximately 50 degrees in a horizontal direction relative to the ball pivot.

16. The door check for a cabinet according to claim 1, wherein a central axis of the rod is coincident to a centroid of the ball pivot, and wherein the central axis of the rod remains coincident to the centroid of the ball pivot during articulation or strokes of the door check.

17. The door check for a cabinet according to claim 1, wherein a central axis of the rod and a central axis of the passages of the first guide and the second guide are coincident.

18. The door check for a cabinet according to claim 1, wherein the socket ends include a concave or cup-like shape that partially receives the spherical or rounded exterior surface of the ball pivot, wherein the ball pivot and the concave or cup-like shape share a same centroid.

19. The door check for a cabinet according to claim 1, wherein the rod is coincident to a centroid of the ball pivot, and rod is configured to move in multiple planes relative to the ball pivot and still remain coincident to the centroid of the ball pivot.

20. The door check for a cabinet according to claim 1, wherein the socket end of the first guide and the socket end of the second guide are configured to move or slide against opposite sides of the spherical or rounded exterior surface of the ball pivot, and the socket ends maintain the rod in alignment or passing through a centroid of the ball pivot.

21. A door check for a cabinet, comprising:
a rod;
a ball pivot, the ball pivot comprising a passage, the ball pivot comprising a spherical or rounded exterior surface;
a first guide comprising a passage, a socket end, and a first spring engagement end;
a second guide comprising a passage, a socket end, and a second spring engagement end;
a first spring comprising an interior;
a second spring comprising an interior;
a middle guide comprising a passage;
a rear spring comprising an interior;
the rod is configured to pass through the interior of the first spring, the passage of the middle guide, the interior of the second spring, the passage of the first guide, the passage of the ball pivot, the passage of the second guide, and the interior of the rear spring;
the middle guide is positioned between the first spring and the second spring;
the first spring is configured to bias or abut against the second spring;
the second spring is configured to bias or abut against the first spring engagement end; and
the rear spring is configured to bias or abut against the second spring engagement end.

22. A door check for a cabinet, comprising:
a rod;
a rod support comprising a passage;
a first spring comprising a first end, a second end, and an interior;
a second spring comprising a first end, a second end, and an interior;
a guide comprising a passage, a first end proximate the rod support, and a second end proximate the second spring;
the rod is configured to pass through the interior of the first spring, the interior of the second spring, the passage of the guide, and the passage of the rod support; and
wherein the first spring is configured to bias or abut against the second spring, and wherein the second spring is configured to bias or abut against the second end of the guide.

23. A door check for a cabinet, comprising:
a rod;
a rod support comprising a passage;
a first spring;
a second spring;
a first spring comprising a first end, a second end, and an interior;
a second spring comprising a first end, a second end, and an interior;
a rear spring comprising a first end, a second end, and an interior;
the rod is configured to pass through the interior of the first spring, the interior of the second spring, the passage of the rod support, and the interior of the rear spring;
wherein the first spring is configured to bias or abut against the second spring, wherein the second spring is configured to bias or abut against a first side of the rod support, wherein the rear spring is configured to bias or abut against a second side of the rod support; and
wherein the rear spring includes a conical spring.

24. A door check for a cabinet, comprising:
a rod;
a ball guide, the ball guide comprising a ball portion and a passage, the ball portion comprising spherical or rounded exterior surface, the passage passes through the ball portion, and the passage is configured to receive the rod; and
a support structure, the support structure comprising an interior and a socket surface, the interior of the support structure is configured to receive the ball portion of the ball guide in a movable engagement against the socket surface.

25. The door check for a cabinet according to claim 24, further comprising a first spring comprising an interior, a second spring comprising an interior, and a rear spring comprising an interior, the rod is configured to pass through the interior of the first spring, the interior of the second spring, the passage of the ball guide, and the interior of the rear spring.

26. The door check for a cabinet according to claim 25, wherein the ball guide further comprises a first spring engagement end and second spring engagement end on opposite sides of the ball guide, wherein the second spring is configured to bias or abut against the first spring engagement end, and the rear spring is configured to bias or abut against the second spring engagement end.

27. The door check for a cabinet according to claim 24, wherein the support structure comprise an upper portion and a lower portion, and the upper portion and the lower portion are configured to join together to hold or receive the ball portion of the ball guide in the movable engagement.
